(19) United States
(12) Patent Application Publication
(10) Pub. No.: US 2016/0203693 A1
(43) Pub. Date: Jul. 14, 2016

(54) Safety Device for Use in a Bathroom

(71) Applicant: I-SHOU UNIVERSITY, Kaohsiung City (TW)

(72) Inventors: Tsung-Cheng Wu, Kaohsiung City (TW); Tun-Hsueh Chan, Kaohsiung City (TW); Shih-Chiang Lin, Kaohsiung City (TW); Gwo-Long Lin, Kaohsiung City (TW); Ho-Hsuan Chang, Kaohsiung City (TW)

(21) Appl. No.: 14/630,725

(22) Filed: Feb. 25, 2015

(30) Foreign Application Priority Data
Jan. 14, 2015 (TW) 104101211

(51) Int. Cl. G08B 21/04; G08B 21/18

(52) U.S. Cl. CPC G08B 21/0461; G08B 21/182

(57) ABSTRACT

A safety device for use in a bathroom includes a float and a detecting and controlling assembly. The float has a housing defining a receiving space. The detecting and controlling assembly is mounted in the receiving space. The detecting and controlling assembly includes an inclination detector, a processing unit, and a transmitting unit. The inclination detector and the transmitting unit are electrically connected to the processing unit. The inclination detector is adapted to detect a posture of the float and adapted to send a detection signal indicative of the posture of the float to the processing unit. The processing unit processes and analyzes the detection signal and sends out an emergency signal through the transmitting unit.

### BACKGROUND OF THE INVENTION

1. Field of the Invention

The present invention relates to a household safety device and, more particularly, to a safety device for use in a bathroom.

2. Description of the Related Art

Families of persons who cannot go out conveniently, such as elderly people or patients in poor body condition, care safety and comfort of the home living environment are required to avoid injuries resulting from disqualified hardware in the environment when the elderly people or the patients move in the houses.

According to survey, bathrooms are one of the places where household accidents occur most frequently. The floor in the bathroom is often wet due to showering or washing and, thus, could cause slip of elderly people who cannot walk well. Since elderly people have low bone density and have low self-repair capability, bone fracture is apt to occur if an elderly person falls and requires a long period of time for recovery. An elderly person often takes a bath during winter to heat the body. However, it happens from time to time that an elderly person having poor blood vessel elasticity faints or even dies because of dramatic body temperature change while taking off clothes and entering a bathtub in a bathroom. Furthermore, the bathroom is an enclosed space in which the voice of the elderly person could be blocked by the wall or covered by noise when the elderly person is trying to ask help from his or her family or medical personnel when the elderly person finds his or her body is not well and loses his or her actionability. The golden hour is often missed, and treatment could be too late. In the worst scenario, the elderly person dies, leaving tremendous grief and self-blame to his or her family.

Thus, a need exists for a safety device for use in a bathroom to solve the safety risks of elderly people taking a bath.

### SUMMARY OF THE INVENTION

An objective of the present invention is to provide a safety device for use in a bathroom. The safety device can detect the water fluctuation in a bathtub of the bathroom and can send out an alarm to the outside.

The present invention fulfills the above objective by providing a safety device for use in a bathroom. The safety device includes float having a housing defining a receiving space. A detecting and controlling assembly is mounted in the receiving space. The detecting and controlling assembly includes an inclination detector, a processing unit, and a transmitting unit. The inclination detector and the transmitting unit are electrically connected to the processing unit. The inclination detector is adapted to detect a posture of the float and adapted to send a detection signal indicative of the posture of the float to the processing unit. The processing unit processes and analyzes the detection signal and sends out an emergency signal through the transmitting unit.

The float can further include an emergency button mounted to an outer periphery of the housing. The emergency button is electrically connected to the processing unit.

The float can further include a temperature sensor mounted to the housing. The temperature sensor includes a detection end extending out of the housing. The temperature sensor is electrically connected to the processing unit.

The detecting and controlling assembly can further include a display unit electrically connected to the processing unit.

The detecting and controlling assembly can further include an alarm unit electrically connected to the processing unit.

The housing can include an upper cover and a lower cover. The upper cover and the lower cover engage with each other and together define the receiving space. The emergency button is mounted to the upper cover. The temperature sensor is mounted to the lower cover.

The present invention will become clearer in light of the following detailed description of illustrative embodiments of this invention described in connection with the drawings.

### BRIEF DESCRIPTION OF THE DRAWINGS

FIG. 1 is an exploded, perspective view of a safety device for use in a bathroom according to the present invention.

FIG. 2 is a cross sectional view of the safety device for use in a bathroom according to the present invention.

FIG. 3 is a block diagram of the safety device for use in a bathroom according to the present invention.

### DETAILED DESCRIPTION OF THE INVENTION

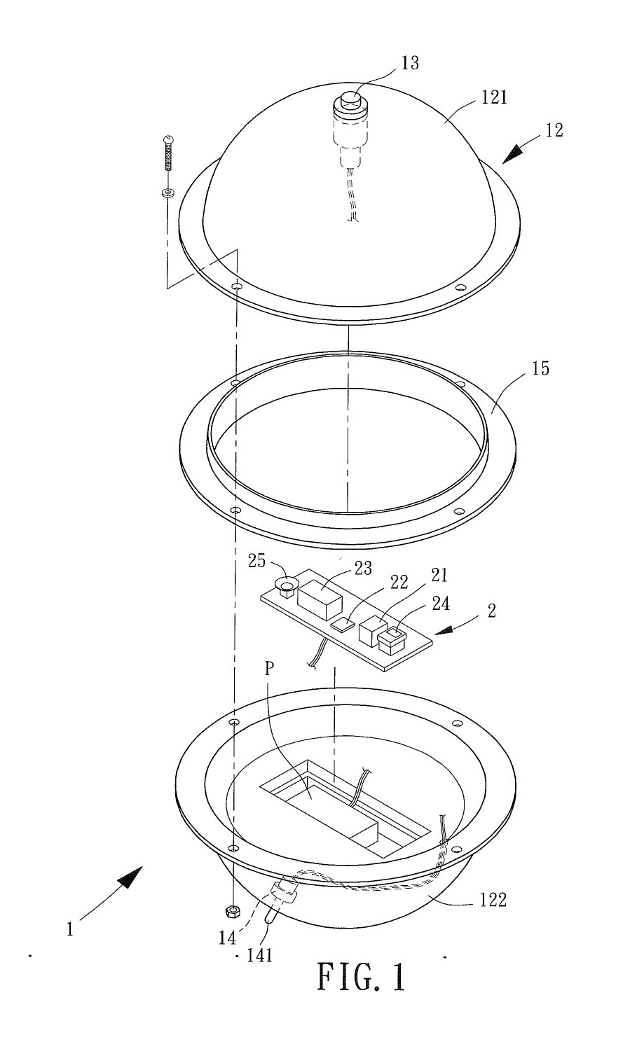

With reference to FIGS. 1-3, a safety device for use in a bathroom according to the present invention includes a float 1 and a detecting controlling assembly 2. The float 1 includes a housing 12 defining a receiving space 11, and the detecting and controlling assembly 2 is mounted in the receiving space 11. The safety device can be used in a bathtub, such as a bathtub in the bathroom. The float 1 can float on the water in the bathtub. The detecting and controlling assembly 2 can detect the fluctuation of the surface of water in the bathtub and can send out an emergency signal to a person outside of the bathroom in time.

Specifically, the float 1 is an object having a specific weight smaller than water and, thus, can float on the surface of water in the bathtub. The float 1 includes the housing 12, an emergency button 13, and a temperature sensor 14. The receiving space 11 is defined in an interior of the float 1 and is isolated from the outside to avoid water in the bathtub or vapor in the bathroom from entering the receiving space 11 and damaging the detecting and controlling assembly 2 in the receiving space 11. The housing 12 defines the receiving space 11. The emergency button 13 is mounted to an outer periphery of the housing 12. The temperature sensor 14 is adapted to detect the temperature of the water in the bathtub. The temperature sensor 14 includes a detection end 141 mounted to the housing 12. Preferably, the detection end 141 extends out of the housing 12. Preferably, the emergency button 13 and the detection end 141 of the temperature sensor 14 are mounted to opposite sides of the housing 12, such that when the float 1 is placed in the bathtub, the detection end 141 of the temperature sensor 14 extends out of the outer periphery of the housing 12 and contacts with the water. At the same time, the emergency button 13 floats above the water surface, permitting a user to press the emergency button 13.

The housing 12 is made of waterproof material, such as acrylic or any other polymer material, to avoid the ambient water from entering the receiving space 11 via the housing 12. The housing 12 can be of any shape. In this embodiment, the housing 12 is a transparent ball and includes an upper cover 121 and a lower cover 122. The upper cover 121 and the lower cover 122 engage with each other and together define the receiving space 1. The emergency button 13 is mounted to the upper cover 121, and the temperature sensor 14 is mounted to the lower cover 122. The engagement between the upper cover 121 and the lower cover 122 can be screwing (as illustrated in this embodiment), bonding, male/female coupling, gluing, or snapping. Preferably, the float 1 can further include a sealing ring 15 mounted between the upper cover 121 and the lower cover 122 to increase the sealing effect for the receiving space 11 for the purposes of effectively isolating the water and the vapor. The sealing ring 15 is preferably made of elastic rubber. It can be appreciated that the float 1 shown is merely a practicable example. The actual shape and components of the float 1 are not limited to this example.

With reference to FIGS. 1-3, the detecting and controlling assembly 2 is mounted in the receiving space 11. In this embodiment, the detecting and controlling assembly 2 is mounted to the lower cover 122, such that the center of gravity of the safety device is located in the lower cover 122. Thus, when the safety device is placed in the bathtub, the detection end 141 of the temperature sensor 14 is submerged into the water, and the emergency button 13 is above the water surface. The detecting and controlling assembly 2 includes an inclination detector 21, a processing unit 22, and a transmitting unit 23. The inclination detector 21 and the transmitting unit 23 are electrically connected to the processing unit 22. Furthermore, the emergency button 13 and the temperature sensor 14 of the float 1 are also electrically connected to the processing unit 22. Furthermore, the transmitting unit 23 is coupled to an external emergency response unit. The coupling between the transmitting unit 23 and the emergency response unit can be achieved by a wire or wireless medium or a combination thereof, such as a heterogeneous network, such that the data between the transmitting unit 23 and the emergency response unit can be transmitted to each other, which can be appreciated by a person having ordinary skill in the art.

More specifically, the inclination detector 21 is adapted to detect a posture of the float 1, such as detecting the float 1 is in an upright or inclined posture, and is adapted to send a detection signal indicative of the posture of the float 1 to the processing unit 22. The processing unit 22 processes and analyzes the detection signal and sends the processed detection signal to the transmitting unit 23, which, in turn, can send out an emergency signal. The emergency signal is received by the external emergency response unit. In this way, a person outside of the bathroom can be notified. In this embodiment, the inclination detector 21 is a gyroscope, the processing unit 22 is a digital microcontroller, and the transmitting unit 23 is ZigBee. The emergency button 13 and the temperature sensor 14 are also electrically connected to the processing unit 22, such that a signal resulting from pressing the emergency button 13 and a temperature signal resulting from temperature detection by the temperature sensor 14 can be sent to the processing unit 22 for analysis and judgment.

The detecting and controlling assembly 2 can further include a display unit 24 electrically connected to the processing unit 22. The display unit 24 can display the temperature value detected by the temperature sensor 14. Furthermore, the detecting and controlling assembly 2 can further include an alarm unit 25 electrically connected to the processing unit 22. The electrical signal generated as a result of pressing the emergency button 13 or generated by the inclination detector 21 can be processed and analyzed by the processing unit 22 and can be then converted into light or sounds, which can be outputted by the alarm device 25. The display unit 24 can be a display panel, a light-emitting diode, or a buzzer. The alarm unit 25 can be a buzzer. It can be appreciated that other forms of the display unit 24 and the alarm unit 25 capable of outputting the signals from the processing unit 22 to achieve the above functions can be used in the present invention. In this embodiment, the display unit 24 is a display panel, is mounted to the lower cover 122, and is received in the receiving space 11. Since the housing 12 in this embodiment is transparent, the user can see the signal outputted by the display unit 24 via the transparent 12.

Note that the external emergency response unit is mounted outside of the bathroom and can receive the emergency signal from the transmitting unit 23. The emergency signal can be presented by actual physical properties, such as light or sound. Alternatively, the electrical signal can be transmitted to a platform through which the message can further be sent out to be displayed on a digital product, such as a cell phone or a tablet computer. As an example, the external emergency response unit can be a buzzer or a lamp for producing sounds or light. Alternatively, the emergency response unit can be an application software (APP) for a smart phone or a tablet computer. Specifically, when the transmitting unit 23 receives the emergency signal from the processing unit 22, the emergency signal can be transmitted to the external emergency response unit. In this case, the external emergency response unit produces sounds or light to catch the attention of persons outside of the bathroom, reminding the persons to go to the bathroom and take a look at the bather. In a case that the external emergency response unit is an application software for a 3C product, the 3C product can, upon reception of the emergency signal from the transmitting unit 23, automatically call or send a message to a caretaker to remind the caretaker of possible dangerous situations of the bather.

Furthermore, the safety device further includes a power supply “P” for supplying electricity to the components of the safety device, such as the inclination detector 21, the processing unit 22, the transmitting unit 23, and the display unit 24 of the detecting and controlling assembly 2 and the temperature sensor 14, which can be appreciated by a person having ordinary skill in the art. In this embodiment, the power supply “P” is mounted in the receiving space 11 of the float 1.

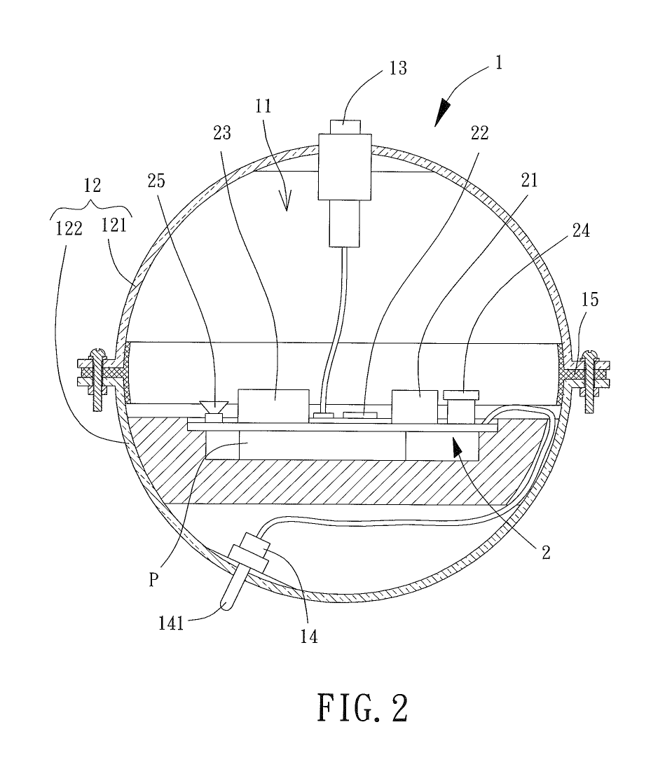

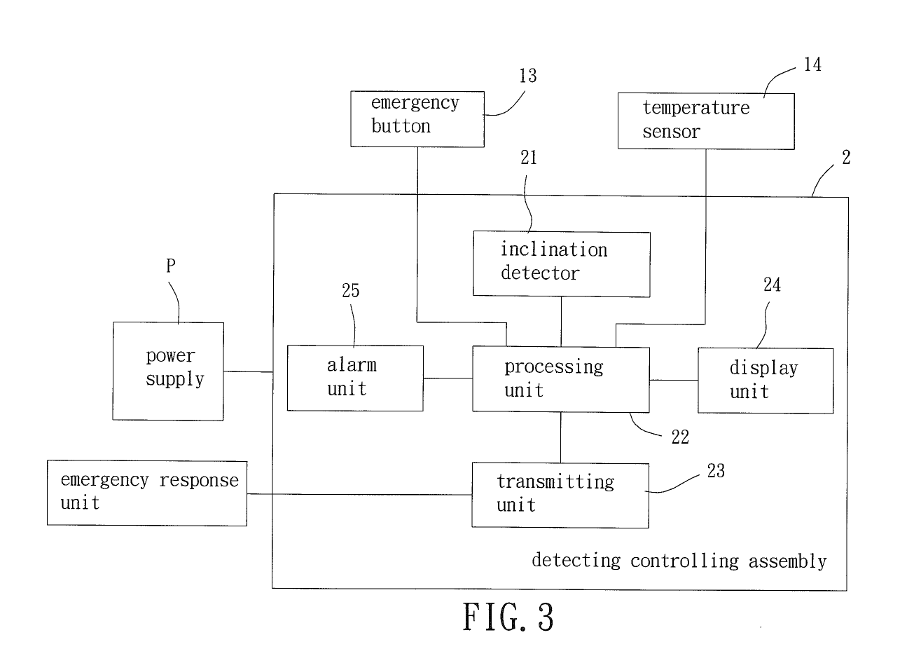

Still referring to FIGS. 2 and 3, when the bather is taking a bath, the safety device is placed into the bathtub. Since the water in the bathtub will fluctuate when the bather stirs the water or wipes the body with a tower, the safety device moves up and down and rocks along with fluctuation of the water. The inclination detector 21 of the safety device continuously detects the posture of the float 1, and the detection signal is transmitted to the processing unit 22. The fluctuation conditions of the water surface in the bathtub can be obtained by analysis and judgment of the posture changing frequency between the upright posture and the inclined posture of the float 1 by the processing unit 22, and the processing unit 22 decides whether to send signals to the transmitting unit 23. Specifically, when the bather faints or falls into sleep due to a change in the physical status (such as a sudden increase or decrease in the blood pressure), the water fluctuation becomes smaller, and the inclination detector 21 detects the posture of the float 1 and sends the detection signal to the processing unit 22. The processing unit 22 identifies this situation as abnormal and sends an emergency signal to the transmitting unit 23, which, in turn, sends the emergency signal to the external emergency response unit for sending an alarm message to the outside, notifying the caretaker or any person outside of the bathroom to take a look at the bather. At the same time, since the processing unit 22 is electrically connected to the alarm unit 25, the processing unit 22 also sends the signal to the alarm unit 25, such that the safety device produces sounds to wake up the bather or to attracting attention of persons nearby, such that the persons can be aware of the potential accident and take care of it.

Furthermore, the bather can place the safety device into the bathtub before taking a bath, permitting the safety device to float on the water surface while the detection end 141 of the temperature sensor 14 is submerged into the water and the emergency button 13 is located above the water surface. The temperature detected by the detection end 141 is processed and converted by the processing unit 22 into a temperature signal. Since the processing unit 22 is electrically connected to the display unit 24, the temperature signal can be outputted by the display unit 24 to provide the bather with information indicating whether the water temperature is appropriate.

While the bather is taking off the clothes, washing the body, bathing, or changing the clothes, if the bather feels uncomfortable but still has consciousness and certain actionability, the bather can press the emergency button 13 to make the processing unit 22 generate an emergency signal and send the emergency signal to the transmitting unit 23. The transmitting unit 23 coupled to the external emergency response unit urges the external emergency response unit to output the emergency signal. Also, the processing unit 22 can send the emergency signal to the alarm unit 25 at the same time to notify the caretaker outside of the bathroom to take a look at the bather.

In view of the foregoing, the safety device for use in a bathroom according to the present invention includes the float 1 and the detecting and controlling assembly 2 received in the receiving space 11 of the float 1. The inclination detector 21 of the detecting and controlling assembly 2 detects fluctuation of the water surface in the bathtub and generates a detection signal to the processing unit 22 for analyzing the judging the detection signal. When the bather faints and does not move anymore, the processing unit 22 sends a signal to the transmitting unit 23 after analysis of the detection signal from the inclination detector 21. The transmitting unit 23 can send an alarm to the caretaker through the external emergency response unit, notifying the caretaker to take a look at the bather. Thus, the time required for the caretaker to find out fainting of the bather can be greatly reduced, such that the caretaker can send the fainted bather to the hospital for emergency aid in the golden hour, increasing the bathing safety for elderly people.

Furthermore, since the safety device includes the temperature sensor 14 and the display unit 24 that are electrically connected to the processing unit 22, the temperature signal from the temperature sensor 14 can be outputted through the display unit 24 as light, words, images, or sounds after analysis by the processing unit 22. Thus, the bather can know whether the water temperature is appropriate before entering the bathtub, avoiding the bather from scalding.

Furthermore, since the safety device for use in a bathroom according to the present invention includes the emergency button 13 electrically connected to the processing unit 22, when the bather entering the bathroom changes the clothes, washes or takes a bath, the bather can press the emergency button 13 if the bather fells uncomfortable or falls and is, thus, unable to walk out of the bathroom to ask for help. The signal can be sent via the detecting and controlling assembly 2 to the outside, notifying the caretaker to look over the bathroom. Thus, the occasions of undiscovered bathroom accidents can be reduced.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A safety device for use in a bathroom, comprising:
a float including a housing defining a receiving space; and
a detecting and controlling assembly mounted in the receiving space, with the detecting and controlling assembly including an inclination detector, a processing unit, and a transmitting unit, with the inclination detector and the transmitting unit electrically connected to the processing unit, with the inclination detector configured to detect an inclined posture and fluctuations in posture of the float and configured to send a detection signal indicative of the inclined posture and the fluctuations in posture of the float to the processing unit, with the processing unit processing and analyzing the detection signal and configured to judge whether to send out an emergency signal through the transmitting unit.

2. The safety device for use in the bathroom as claimed in claim 1, with the float further including an emergency button mounted to an outer periphery of the housing, and with the emergency button electrically connected to the processing unit.

3. The safety device for use in the bathroom as claimed in claim 1, with the float further including a temperature sensor mounted to the housing, with the temperature sensor including a detection end extending out of the housing, and with the temperature sensor electrically connected to the processing unit.

4. The safety device for use in the bathroom as claimed in claim 1, with the detecting and controlling assembly further including a display unit electrically connected to the processing unit.

5. The safety device for use in the bathroom as claimed in claim 1, with the detecting and controlling assembly further including an alarm unit electrically connected to the processing unit.

6. The safety device for use in the bathroom as claimed in claim 3, with the housing including an upper cover and a lower cover, with the upper cover and the lower cover engaged with each other and together defining the receiving space, with the float further including an emergency button mounted to an outer periphery of the housing, with the emergency button electrically connected to the processing unit, with the emergency button mounted to the upper cover, and with the temperature sensor mounted to the lower cover.
